(19) United States
(12) Patent Application Publication
(10) Pub. No.: US 2002/0020597 A1
(43) Pub. Date: Feb. 21, 2002

(54) Manual transmission synchronizer for automobiles

(76) Inventor: Chang-Yeon Cho, Seoul (KR)

Correspondence Address: BIRCH, STEWART, KOLASCH & BIRCH, LLP, P.O. Box 747, Falls Church, VA, 22040-0747, US

(21) Appl. No.: 09/739,638

(22) Filed: Dec. 20, 2000

(30) Foreign Application Priority Data
Aug. 21, 2000 (KR) 2000-48283

(51) Int. Cl. F16D 23/06

(52) U.S. Cl. 192/53.343; 74/339

(57) ABSTRACT

Disclosed herein is a manual transmission synchronizer for automobiles. The manual transmission synchronizer is operated in such a way that a sleeve engaged with a clutch hub is moved in the direction of the manipulation of a gearshift lever by the manipulation of the gearshift lever, synchronizer keys push a synchronizer ring due to the movement of the sleeve, the synchronizer ring is brought into tight contact with and synchronized with the cone portion of a clutch gear by the pushing of the synchronizer ring, and the gear portions of the synchronizer ring and the clutch gear are moved into and engaged with the inner gear portion of the sleeve, thereby performing the shifting of gears. In the manual transmission synchronizer, the gear portion of the clutch hub is formed such that a part of the gear sub-portions situated between each pair of neighboring grooves of the clutch hub is extended to its both sides by a predetermined length, and the gear portions of the synchronizer rings are formed such that the gear sub-portions of the gear portions of the two synchronizer rings situated inside of each extended gear sub-portion of the clutch hub when the synchronizer rings are assembled with the clutch hub are not geared.

### BACKGROUND OF THE INVENTION

1. Field of the Invention

The present invention relates generally to a manual transmission synchronizer for automobiles, and more particularly to a manual transmission synchronizer in which the several sub-portions of the gear portion of its clutch hub are extended, thereby reducing the vibration of its sleeve and improving the smoothness of gear shifting.

2. Description of the Prior Art

A transmission for automobiles is a part of a power train. The transmission is situated between a clutch and a drive shaft, and serves to selectively increase and decrease the rotating force of an engine depending upon driving conditions. The transmission is provided with a reverse gear.

Such transmissions may be classified into an automatic transmission in which gear shifting is automatically performed depending upon current driving conditions and a manual transmission in which gear shifting is performed by a driver's manipulating a gearshift lever. The present invention is concerned with the latter manual transmission.

Meanwhile, the gear meshes of manual transmissions may be classified into a slide mesh type transmission, a constant mesh type transmission and a synchromesh type transmission. Currently, manual transmissions mainly employ a synchromesh type that is designed to overcome the shortcomings of the slide mesh type and the constant mesh type.

As illustrated in FIG. 5, the synchronizer of the synchromesh type transmission includes a clutch hub 104 that is fitted around a main spindle 102 in a spline engagement fashion and is provided at its circumferential surface with a plurality of grooves 106.

A plurality of synchronizer keys 108 are disposed in the grooves 106 of the clutch hub 104. A sleeve 110 is situated around the clutch hub 104 to be axially movable. The synchronizer keys 108 are elastically supported by springs 122 to be brought into contact with the inner surface of the sleeve 110.

Two speed gears 112 are situated with one on each side of the sleeve 110 to prevent rotational interference with the main spindle 102. Two clutch gears 116 each having a cone portion 114 are situated on the inner sides of the speed gears 112, respectively. Two synchronizer rings 118 are respectively situated on the cone portions 114 of the clutch gears 116, thus causing friction due to contact during the shifting of gears.

The synchronizer rings 118 are threaded on their inner surfaces to increase friction with the cone portions 114 of the clutch gears 116. A plurality of pairs of slots 120 are formed along the circumferential surfaces of the synchronizer rings 118 while being regularly spaced apart from one another, and each of the synchronizer keys 108 is disposed at its both ends in each pair of slots 120. The synchronizer keys 108 are elastically supported by the springs 122, thus being brought into contact with the inner surface of the sleeve 110 by the elastic force of the springs 122.

In the synchromesh type transmission, when a gearshift lever (not shown) is manipulated, the sleeve 110 is moved in a direction in which the gearshift lever is manipulated. In this case, the sleeve 110 pushes the synchronizer keys 108, which are engaged with their grooves, in the manipulation direction, so that the side ends of the synchronizer keys 108 push the side walls of the slots 120 of the synchronizer ring 118.

When the sleeve 110 is moved further, the threaded inner surfaces of the synchronizer rings 118 are brought into contact with the cone portions 114 of the clutch gears 116, thereby transmitting a rotating force to the speed gears 112 by the action of friction.

When the synchronizer rings 118 are synchronized with the speed gears 112, the circumferential gear portions of the synchronizer rings 118 and the clutch gears 116 are inserted into the inner gear portion of the sleeve 110, SO that the synchronizer rings 118 and the clutch gears 116 are interlocked with the sleeve 110, thereby allowing power to be transmitted.

Referring to FIG. 6, in the conventional synchronizer, since the synchronizer rings 118 and the clutch gears 116 are outside of the clutch hub 104, the length “d” of the gear portion of the clutch hub 104 is relatively short due to the structure of the synchronizer, and the gear portions of the synchronizer rings 118 are exposed to the outside.

As a result, while the sleeve 110 is moved toward the clutch gear 116 to shift gears, the area of contact between the gear portions of the clutch hub 104 and the sleeve 110 is reduced, thereby reducing the force of support to the sleeve 110 and preventing the sleeve 110 from being vibrated.

In a neutral position, the gear portion of the clutch hub 104 is in full contact: with the gear portion of the sleeve 110. However, when the sleeve 110 is moved toward the clutch gear 116 to shift gears, the area of contact between the gear portions of the clutch hub 104 and the sleeve 110 is reduced by the amount of the movement of the sleeve 110. In this state, since the sleeve 110 is not supported until the front end of the gear portion of the sleeve 110 is engaged with the clutch gear 116 and the area of contact between the gear portion of the sleeve 110 and the clutch hub 104 is reduced, thereby causing the sleeve 110 to vibrate.

The great vibration of the sleeve 110 during the shifting of gears prevents the synchronizer rings 118 from being axially pushed precisely, thereby reducing the smoothness of gear shifting.

### SUMMARY OF THE INVENTION

Accordingly, the present invention has been made keeping in mind the above problems occurring in the prior art, and an object of the present invention is to provide a manual transmission synchronizer in which the gear portion of its clutch hub is engaged with the gear portion of its sleeve over the relatively large area of contact, thereby preventing a reduction in the smoothness of gear shifting due to the vibration of the sleeve.

In order to accomplish the above object, the present invention provides a manual transmission synchronizer for automobiles, in which a sleeve engaged with a clutch hub is moved in the direction of the manipulation of a gearshift lever by the manipulation of the gearshift lever, synchronizer keys push a synchronizer ring due to the movement of the sleeve, the synchronizer ring is brought into tight contact with and synchronized with the cone portion of a clutch gear by the pushing of the synchronizer ring, and the gear portions of the synchronizer ring and the clutch gear are moved into and engaged with the inner gear portion of the sleeve, thereby performing the shifting of gears, characterized in that the gear portion of the clutch hub is formed such that a part of the gear sub-portions situated between each pair of neighboring grooves of the clutch hub is extended to its both sides by a predetermined length, and the gear portions of the synchronizer rings are formed such that the gear sub-portions of the gear portions of the two synchronizer rings situated inside of each extended gear portion of the clutch hub when the synchronizer rings are assembled with the clutch hub are not geared.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-section showing a manual transmission synchronizer in accordance with the present invention;

FIG. 2 is a exploded perspective view showing the manual transmission synchronizer;

FIG. 3 is a partial development view of the manual transmission synchronizer in accordance with an embodiment of the present invention;

FIG. 4 is a partial development view of the manual transmission synchronizer in accordance with another embodiment of the present invention;

FIG. 5 is a cross-section showing a conventional manual transmission synchronizer; and

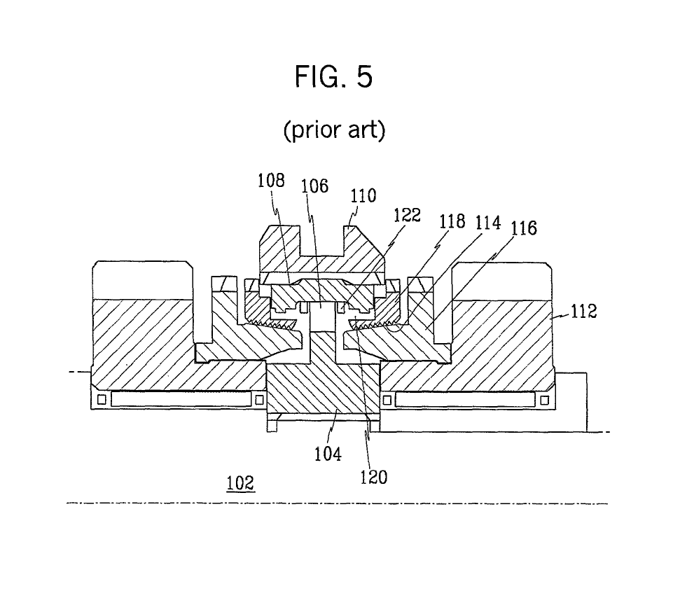

FIG. 6 is a partial development view of the conventional manual transmission synchronizer.

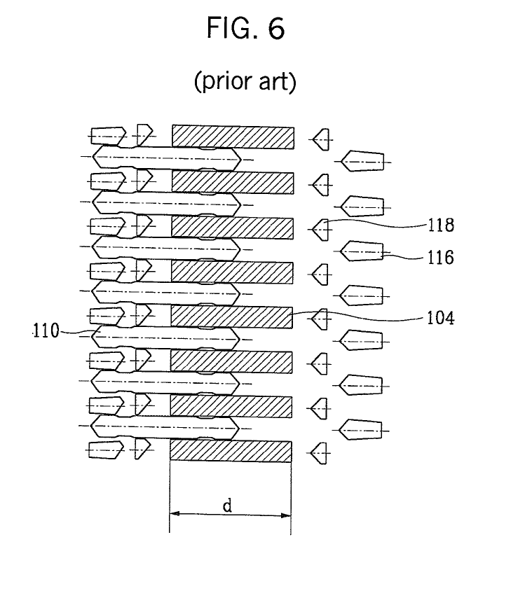

### DESCRIPTION OF THE PREFERRED EMBODIMENTS

Reference now should be made to the drawings, in which the same reference numerals are used throughout the different drawings to designate the same or similar components.

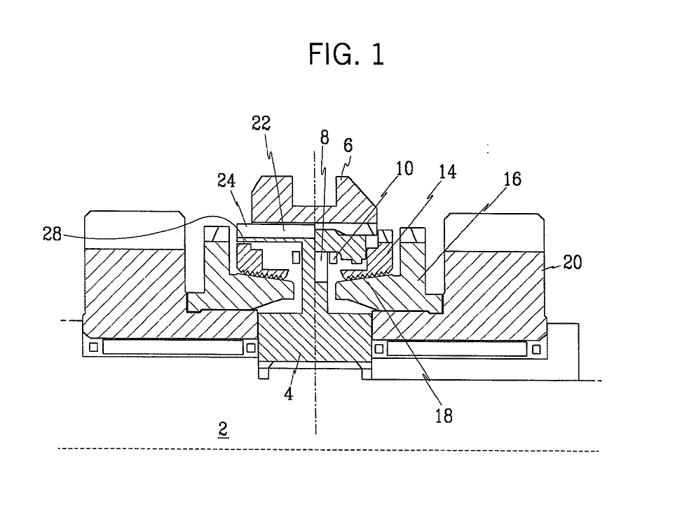

FIG. 1 is a cross-section showing a manual transmission synchronizer in accordance with the present invention. As illustrated in FIG. 1, the synchronizer of the synchromesh type transmission includes a clutch hub 4 that is fitted around a main spindle 2 in a spline engagement fashion and is provided at its circumferential surface with a plurality of regularly spaced grooves 8.

A sleeve 6 is engaged with the circumferential surface of the clutch hub 4 in a spline engagement fashion to be axially movable.

A plurality of synchronizer keys 12 are elastically supported by springs 10 in the grooves 8 of clutch hub 4 to allow the projections of the synchronizer keys 12 to be situated in the inner grooves of the sleeve 6. Two synchronizer rings 14 are situated with one being on each side of the clutch hub 4, and perform the function of clutching due to friction with the cone portions 18 of the clutch gears 16 while being pushed by the synchronizer keys 12 during the shifting of gears. The clutch gears 16 are engaged with the speed gears 20, respectively.

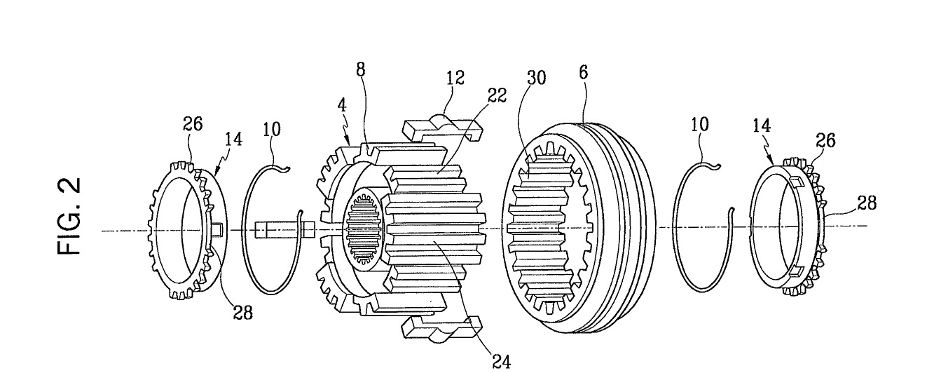

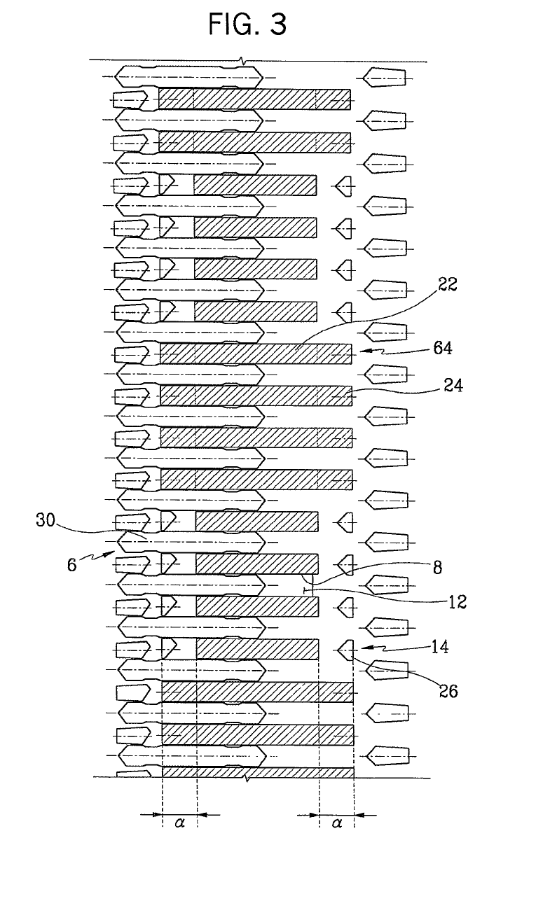

As depicted in FIGS. 2 and 3, in accordance with the present invention, the gear portion of the clutch hub 4 is formed such that the central gear sub-portion 22 of the gear sub-portions 22 situated between each pair of neighboring grooves 8 of the clutch hub 4 is extended to its both sides each by a predetermined length “a” to form an extended gear sub-portion 24, and the gear portions of the synchronizer rings 14 are formed such that the gear sub-portions of the gear portions of the two synchronizer rings 14 situated inside of each extended gear portion 24 of the clutch hub 4 when the synchronizer rings 14 are assembled with the clutch hub 4 are not geared to form two non-geared portions 28.

When the gear portions of the clutch hub 4 and the synchronizer rings 14 are constructed as described above, a state in which the synchronizer is assembled together is as shown in FIG. 3. In this state, the sub-gear portions of the synchronizer ring 14 are exposed in three positions at intervals of 120°, whereas the sub-gear portions 22 of the clutch hub 4 are extended to the sub-gear portions of the synchronizer rings 14 to cover the sub-gear portions 24 of the synchronizer rings 14 in three positions at intervals of 120°.

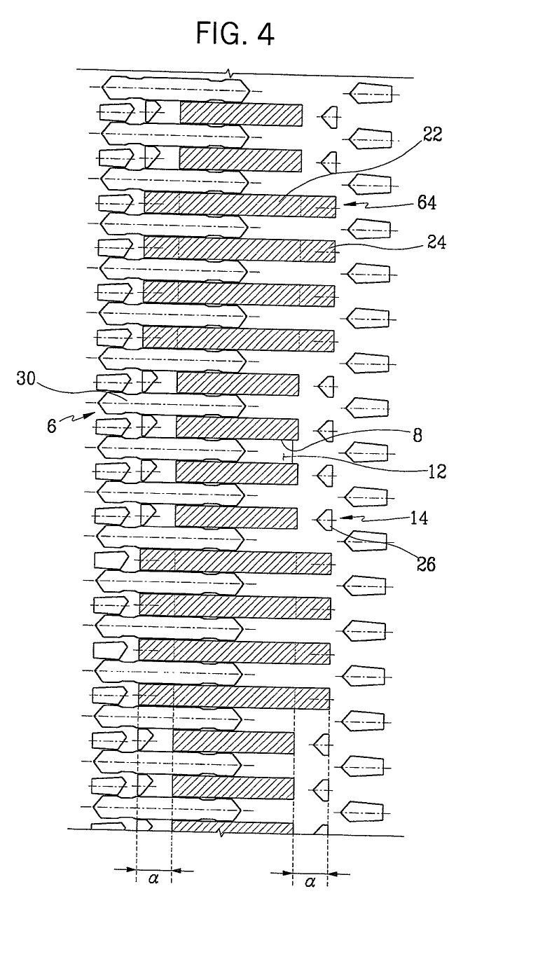

In forming the gear portion of the clutch hub 4 having the extended gear-sub portions 24, although the central gear sub-portion 22 of the gear sub-portions 22 situated between each pair of neighboring grooves 8 of the clutch hub 4 is depicted as extended in FIG. 3, both side gear sub-portions 22 of the gear sub-portions 22 situated between two neighboring grooves 8 of the clutch hub 4, as depicted in FIG. 4, may be extended.

In accordance with the present invention, even though the sleeve 6 is moved to its one side to shift gears, the gear portion of the clutch hub 4 remains in contact with the gear portion of the sleeve 6 due to the extended gear sub-portions of the clutch hub 4, thereby preventing the sleeve 6 from vibrating during the shifting of gears.

In addition, according to the above-construction, the synchronizer rings 14 are accommodated in the extended gear sub-portions of the clutch hub 4, so that the synchronizer rings 14 are precisely moved in an axial direction, thereby improving the smoothness of gear shifting.

As described above, the present invention provides a manual transmission synchronizer in which the gear portion of its clutch hub is engaged with the gear portion of its sleeve over a relatively great length, thereby preventing a reduction in the smoothness of gear shifting during the shifting of gears due to the vibration of the sleeve and the undesirable axial movement of its synchronizer rings.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A manual transmission synchronizer for automobiles, in which a sleeve engaged with a clutch hub is moved in the direction of the manipulation of a gearshift lever by the manipulation of the gearshift lever, synchronizer keys push a synchronizer ring due to the movement of the sleeve, the synchronizer ring is brought into tight contact with and synchronized with the cone portion of a clutch gear by the pushing of the synchronizer ring, and the gear portions of the synchronizer ring and the clutch gear are moved into and engaged with the inner gear portion of the sleeve, thereby performing the shifting of gears, characterized in that,
the gear portion of the clutch hub is formed such that a part of the gear sub-portions situated between each pair of neighboring grooves of the clutch hub is extended to its both sides by a predetermined length, and
the gear portions of two synchronizer rings are formed such that the gear sub portions of the gear portions of the two synchronizer rings situated inside of each extended gear sub-portion of the clutch hub when the synchronizer rings are assembled with the clutch hub are not geared.

2. The manual transmission synchronizer according to claim 1, wherein the extended gear sub-portions of said clutch hub are arranged at intervals of 120°.

3. The manual transmission synchronizer according to claim 1, wherein each extended gear sub-portion of said clutch hub is formed by extending the central gear sub-portion of the gear sub-portions situated between each pair of neighboring grooves of the clutch hub.

4. The manual transmission synchronizer according to claim 1, wherein each pair of extended gear sub-portions of said clutch hub are formed by extending both side gear sub-portions of the gear sub-portions situated between each pair of neighboring grooves of the clutch hub.
